(19) United States
(12) Patent Application Publication
(10) Pub. No.: US 2005/0288967 A1
(43) Pub. Date: Dec. 29, 2005

(54) Methods for centralized data management for electronic patient data in clinical care and multicenter clinical trials

(76) Inventor: Gary Zammit, Norwalk, CT (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/146,487

(22) Filed: Jun. 6, 2005

Related U.S. Application Data
(60) Provisional application No. 60/577,228, filed on Jun. 4, 2004.

(51) Int. Cl. G06F 17/60

(52) U.S. Cl. 705/3

(57) ABSTRACT

Methods for centralized data management for electronic patient data in clinical care and multicenter clinical trials are Web-based. The methods provide secure access to proprietary documents that provide standard operating procedures (SOPs) that may be used for the collection, processing, transfer, and storage of clinical trial data. The methods may also provide access to other functions, such as those that enable data upload, data download, data review, reports, and account management. Customizable reports, such as Executive Narrative Summary Reports, may be generated in accordance with some embodiments.

### CROSS-REFERENCE TO RELATED U.S. APPLICATIONS

This application claims the benefit of co-pending Provisional Application Ser. No. 60/577,228, filed Jun. 4, 2004.

### BACKGROUND

The present invention relates generally to the collection, processing, transfer and storage of clinical trial data in a centralized data management process, including methods and systems for utilizing standardized methodologies to process the electronic patient data. More specifically, the present invention relates to a standardized method of Web-based centralized data management and processing for electronic patient data in multicenter clinical trials.

The use of centralized data processing services is common in multicenter clinical trials. In their simplest forms, such services are used for the processing of paper or digital case report forms (CRFs) at a central location. However, they also have been used in more complex circumstances, such as the handling of biological samples, physiological data, or electronic files. Centralized data processing generally allows data to be acquired in a standardized manner, and processed at a single location using uniform and reliable methods. Clinical trials commonly employ centralized data services for the processing of electrocardiographic (EKG) tracings, and radiographic or other image data collected in multicenter studies.

Centralized data management has been used in clinical trials employing electronic (digital) polysomnographic (PSG) recording. It is important to note that the widespread use of computerized PSG systems has been anticipated for several decades, and these systems are increasingly used in clinical centers. However, the introduction of this technology in clinical trials was made possible by the achievement of three important milestones. First is the work of the Task Force on Signal Analysis sponsored by the “European Concerted Action on Methodology for the Analysis of the Sleep-Wakefulness Continuum.” This group developed the technical standards by which digital PSG data obtained from different manufacturers' systems may be converted into a common format, now known as European Data Format (EDF). Second is the early adoption of central scoring methodologies by leaders in the field of sleep medicine; specifically, Dr. Thomas Roth and his colleagues at the Henry Ford Hospital Sleep Disorders and Research Center in Detroit, Mich. Third, and of significant importance, is the evolution of a regulatory environment that supports the use of digital data in clinical trials. The Code of Federal Regulations (21 CFR, Part 11) released in March 1997, set the standard for the use of electronic data in clinical trials, offering guidelines that sponsors may apply to centralized PSG data processing.

Centralized data processing methods have gained acceptance in the pharmaceutical industry. The application of these methods commonly involves the use of operating procedures developed for use at clinical trials sites, which enable the submission of data to a centralized processing facility. Thus, data from sites involved in multicenter clinical trials are collected, transferred, processed, and stored in a specific and controlled manner. However, there is a significant need for standardized methodologies to be used to process clinical trials data. Such methodologies can result in significant advantages in the drug development process. Using highly standardized methods to process clinical trials data at a central location significantly reduces data processing error rates (including errors of omission, errors of commission, interpretive errors). Other improvements over the current methods and systems include: reducing variability in data acquisition and processing methodologies, thereby reducing statistical variability in clinical trials data; reducing the likelihood of confounds related to characteristics of individual investigators or sites; enabling reliability assessments to be performed in a routinized manner; providing conformity with regulatory requirements regarding clinical trials data management, including 21 CFR, Part 11, which governs the management of electronic data; and providing essential documentation at a single location, facilitating oversight by sponsors and regulatory agencies.

### BRIEF SUMMARY OF THE PREFERRED EMBODIMENTS

Web-based centralized data processing provide a variety of applications in healthcare and clinical trials. For example, clinical data such as electroencephalographic, polysomnographic, electrocardiographic, radiographic (x-ray, MRI, CT, PET or other image), or other forms of patient data collected during the course of a clinical patient assessment can be easily transferred to a central location for standardized processing using a Web-based system. These data can be processed similarly when collected in a multicenter clinical trial, providing the benefits of standardized processing across a wide variety of clinical trial settings.

### BRIEF DESCRIPTION OF THE DRAWINGS

FIG. 1 illustrates an exemplary display of one embodiment of the software application used to facilitate the Web-based, centralized data management process.

FIG. 2 illustrates an exemplary display of one embodiment of the software application used to facilitate the Web-based, centralized data management process.

FIG. 3 illustrates an exemplary display of one embodiment of the software application used to facilitate the Web-based, centralized data management process.

FIG. 4 illustrates an exemplary display of one embodiment of the software application used to facilitate the Web-based, centralized data management process.

FIG. 5 illustrates an exemplary display of one embodiment of the software application used to facilitate the Web-based, centralized data management process.

FIG. 6 illustrates an exemplary display of one embodiment of the software application used to facilitate the Web-based, centralized data management process.

FIG. 7 illustrates an exemplary display of one embodiment of the software application used to facilitate the Web-based, centralized data management process.

FIG. 8 illustrates an exemplary display of one embodiment of the software application used to facilitate the Web-based, centralized data management process.

FIG. 9 illustrates an exemplary display of one embodiment of the software application used to facilitate the Web-based, centralized data management process.

FIG. 10 illustrates an exemplary display of one embodiment of the software application used to facilitate the Web-based, centralized data management process.

FIG. 11 illustrates an exemplary display of one embodiment of the software application used to facilitate the Web-based, centralized data management process.

FIG. 12 is a flow diagram illustrating the submission and processing of data into the Web-based centralized data management system in one embodiment.

FIG. 13 is a flow diagram illustrating the process of generating a narrative summary report using the Executive Narrative Summary Report Generation (“ENSRG”) system, a feature of the Web-based centralized data management system in one embodiment.

### DETAILED DESCRIPTION OF THE PREFERRED EMBODIMENTS

The several figures of displays and drawings illustrate exemplary embodiments and should not be viewed as limitations. In one embodiment, an exemplary software application facilitates a Web-based, centralized data management process. The exemplary software may reside on a server that may or may not connect to the Internet, such that it can be accessed by users who require access.

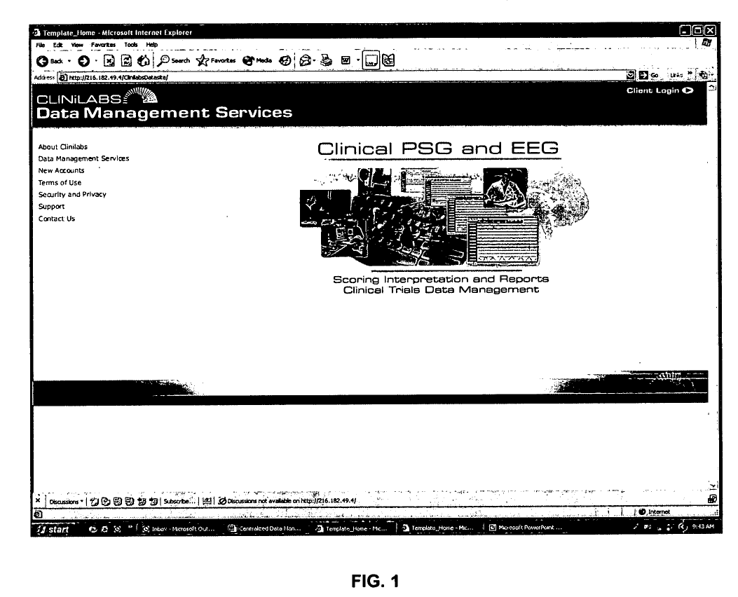

FIG. 1 shows an exemplary home page that is the point of entry to an exemplary Web-based, centralized data management process.

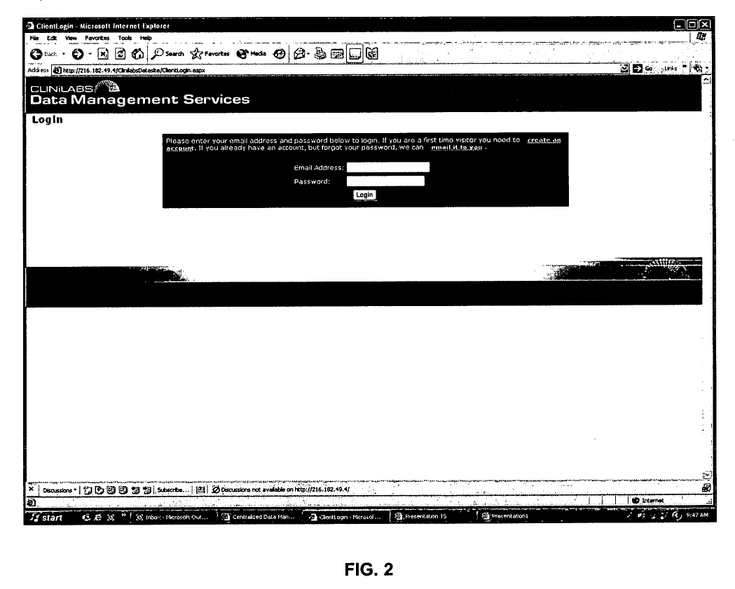

As shown in FIG. 2, a user logs on by entering a unique username and password, allowing the secure user access to the application.

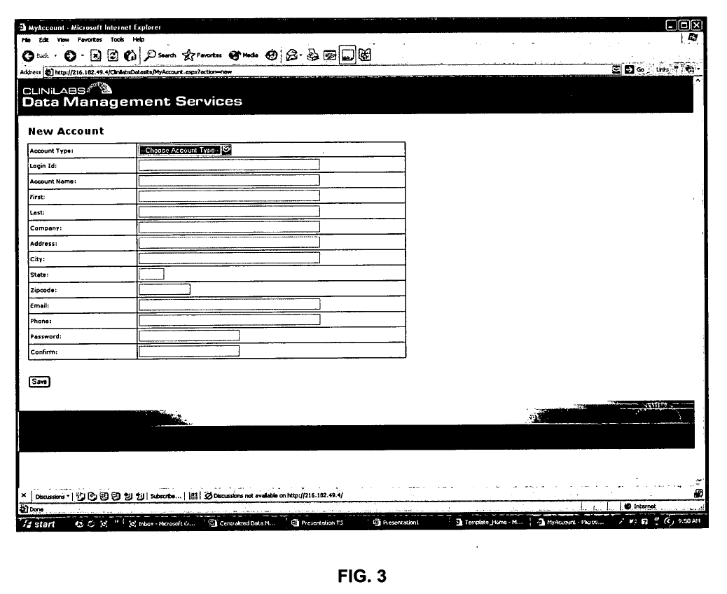

As shown in FIG. 3, after logging into the application, a user can create a new account or modify an existing account by interfacing with an account management module. Account parameters that may be controlled via the account management module may include, but are not limited to, account type, login ID, account name, first and last name of a user, company name, street address, email address, telephone numbers, password, and any other account parameters that may be desired.

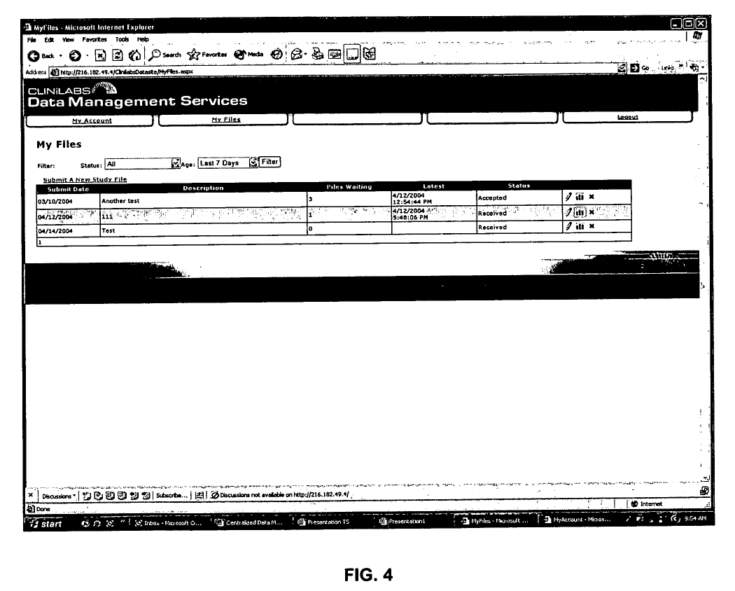

After logging in, the user has access to proprietary documents that provide standard operating procedures (SOPs) that may be used for the collection, processing, transfer, and storage of clinical trial data. The user also may access other functions, such as those that enable data upload, data download, data review, reports, and account management, as shown in FIGS. 4, 5, and 6.

With reference to FIG. 4, data that are collected at the user's site may be transferred to a centralized location for processing. This may be accomplished, as illustrated in FIG. 4, by navigating to the “My Files” area of the application, which enables a user to select “Submit A New Study File” in order to input additional study data.

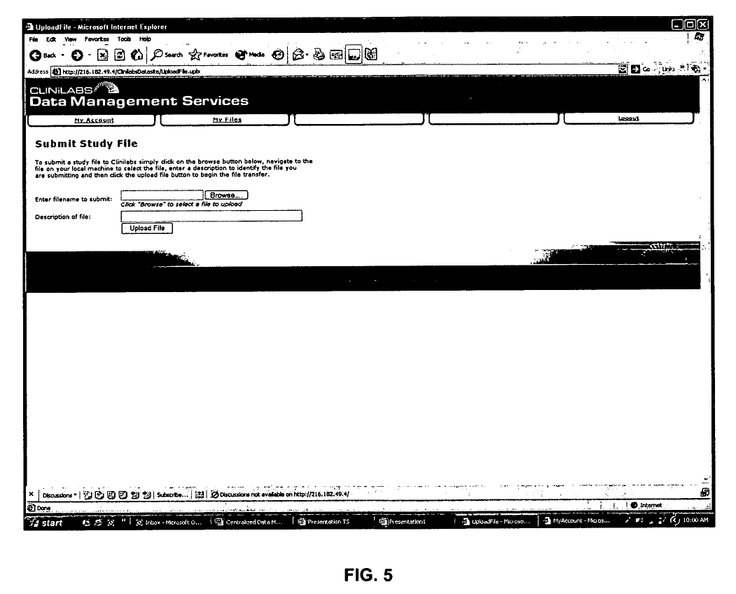

The user may enter a filename or browse to select a filename, which identifies the file to be transferred, as shown in FIG. 5. The user may then submit the file, which is transmitted over the Internet or other suitable network. A log of the sent file is entered at the centralized location. Files that are submitted are encrypted to ensure compliance with HIPAA guidelines and 21 CFR Part 11 and any other applicable laws and/or regulations. Files are decrypted once they are received at the centralized location. Functions enabled for the user in the exemplary display in FIG. 5 include, but are not limited to user browsing, uploading, downloading, printing and editing data and/or study files.

In one embodiment, files for transfer to the Web-based application can be “stacked” for transfer, so that a user may load all files for transfer at one time. In addition, users receive automatic documentation that files have been received. Once data are submitted, the user may obtain a status report of the file. This enables the user to determine if and when the file was sent, if and when the file was received, if and when the file was accepted for processing, when the file entered the processing stage, when processing of the file was completed, if the processing failed, and if reprocessing was requested.

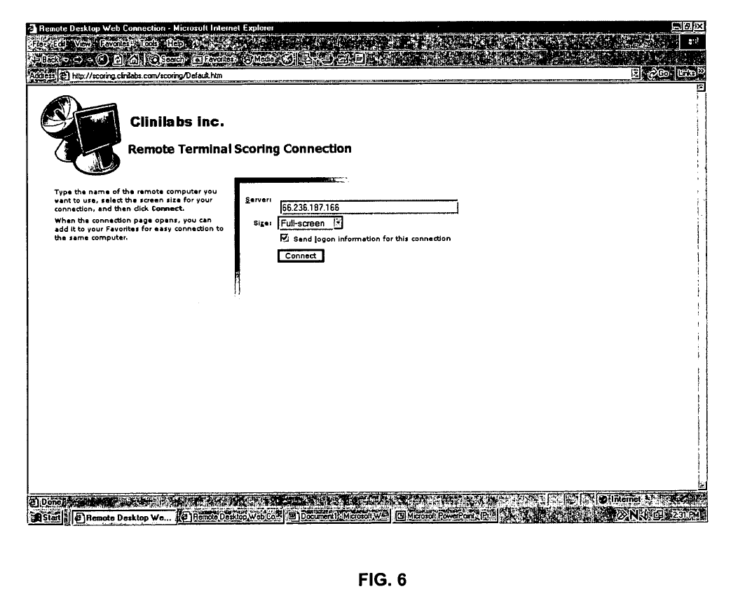

Referring now to FIG. 6, after data are received they can be processed by individuals who have remote access to our server, using a “Remoter Terminal Scoring Connection” application. Data processors can log on to the server using a secure username and password, as shown in FIG. 6, and process data using a data processing application.

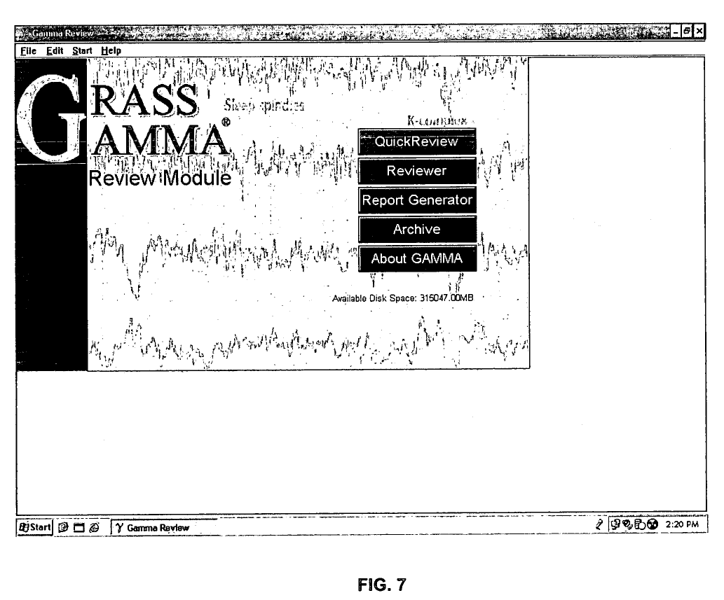

As just one example of a data processing application, data processors can log into the Grass Gamma software application for data processing, as shown in FIGS. 7-10. In one embodiment, data processors can remotely access the data processing application via the Remote Terminal Scoring Connection, access files of the remote servers, including the data transferred by Internet users for processing, and open files for review and analysis. Data files never leave the server during processing. This facilitates the maintenance of security and also allows auditing of user access and file activity.

Processing of files is achieved in a standardized manner, using standardized SOPs for data processing. These SOPs include reliability and quality control checks that are designed to detect errors. For example, in the case of PSG data, files are processed according to accepted scoring procedures for sleep, arousals, respiratory events, and limb movement events. A percentage of all files processed are processed a second time by an independent rater in order to assess inter-rater reliability. Quality control is further handled by the software application, which automatically searches for key values that are “out of range,” as well as a human review of data to identify errors.

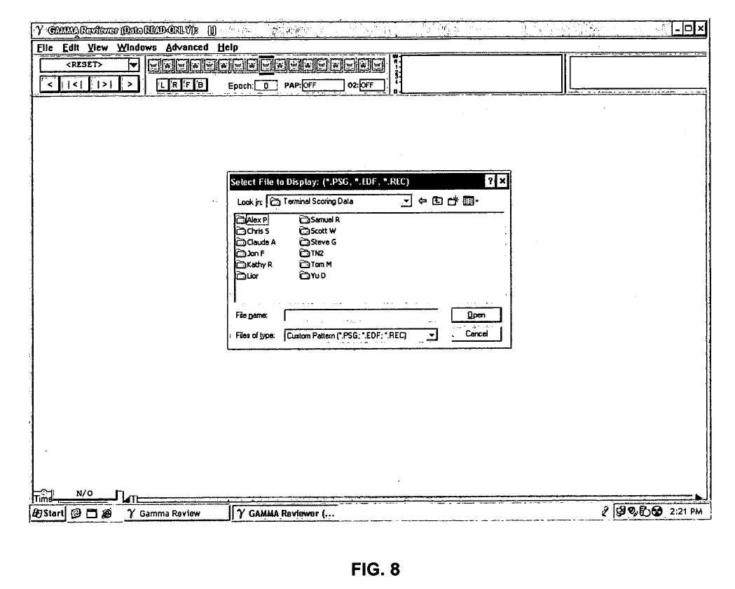

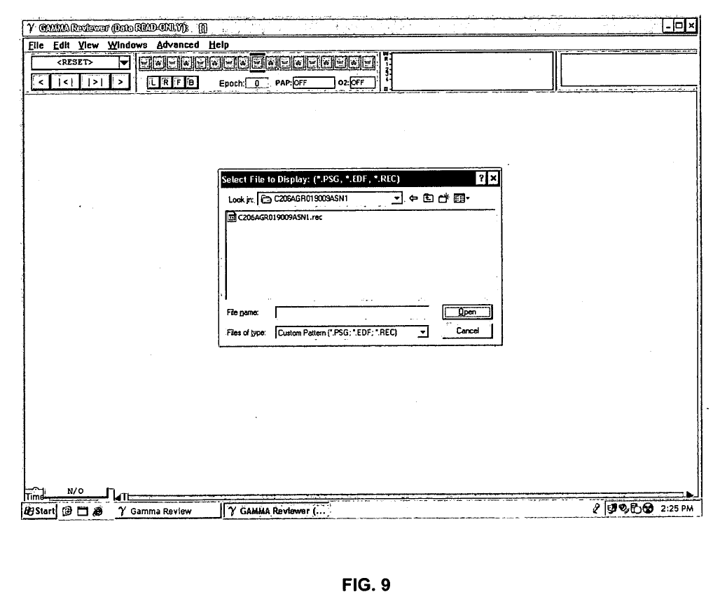

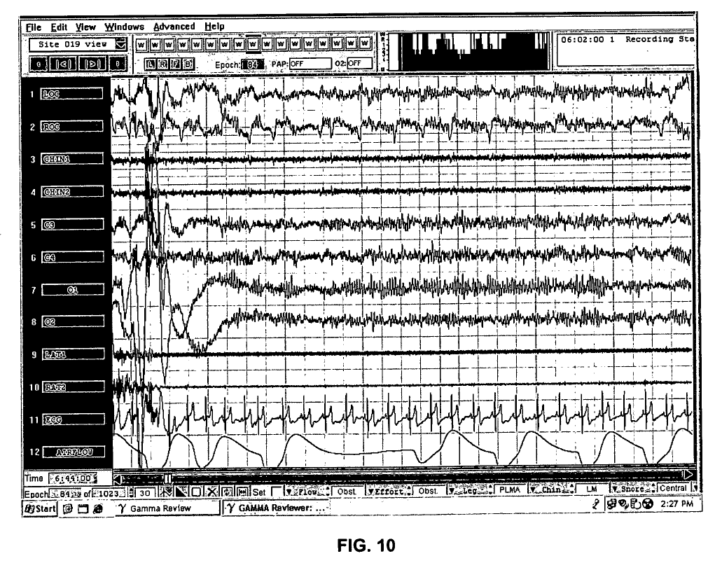

A display from the Grass Gamma Review Module, for processing data, generating reports, and archiving data and reports, is shown in FIG. 7. FIGS. 8 and 9 are screenshots of the Grass Gamma Review Module data processing application used in this exemplary embodiment to facilitate the Web-based, centralized data management process. Other data processing applications may be used without departing from the spirit and scope of the invention. As shown in FIGS. 8 and 9, data processing applications such as the Grass Gamma Review Module provide a number of data processing options to the data processor, including, for example, opening a file for review. FIG. 10 shows an exemplary of screenshot of the display of a file that has been opened for review via the exemplary data processing application.

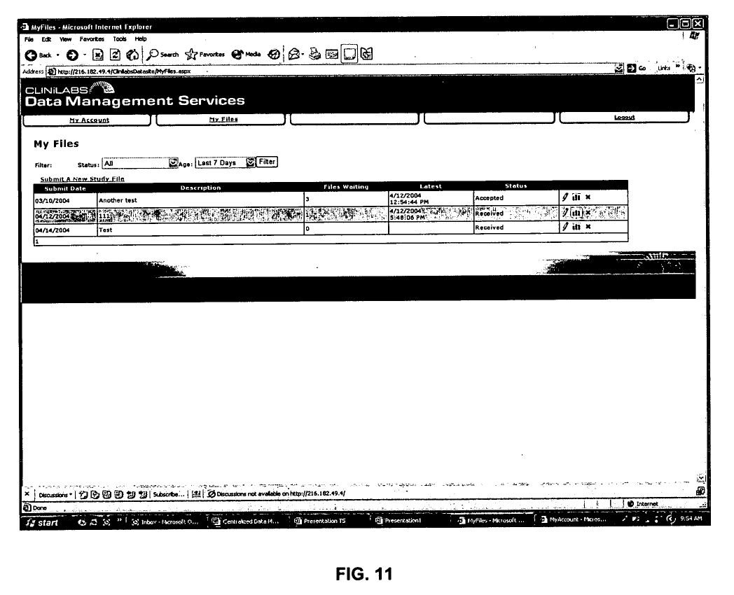

Once files are processed, the raw data, processed data, results, and reports may be put into a database or posted to the Website application or otherwise appropriately handled. For example, the user may request the transfer of electronic files. As shown in FIG. 11, the display illustrates the functions enabled for the user when visiting the Website, including identifying a desired file, and then printing, transferring, or downloading the file.

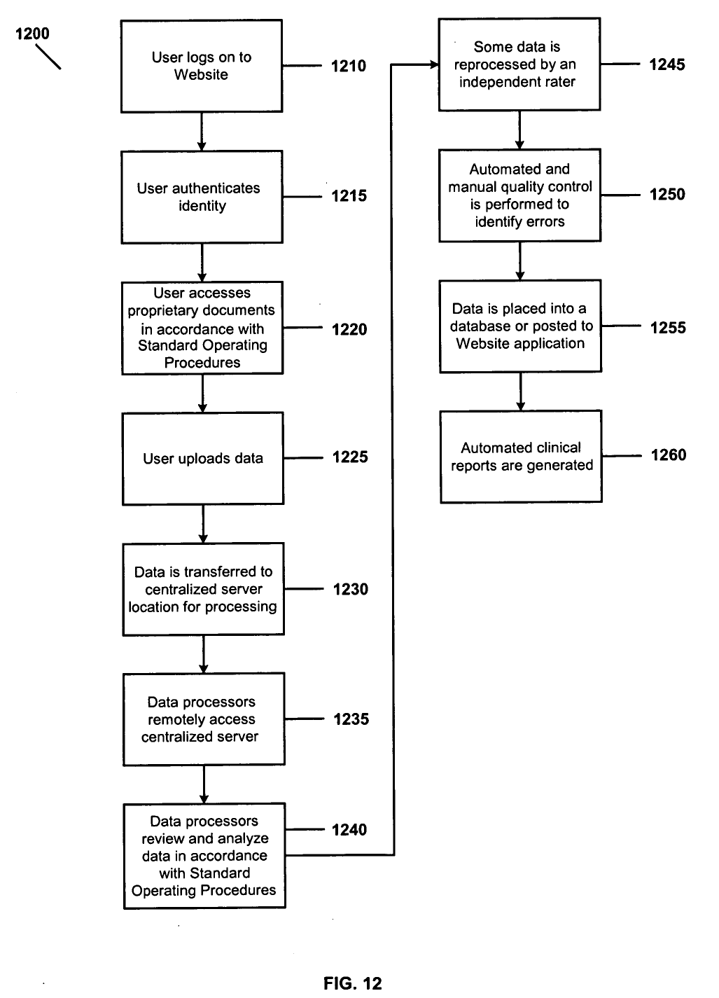

FIG. 12 is a flow diagram illustrating the submission and processing of data into the Web-based centralized data management system in one embodiment. By way of example and without limitation, process 1200 aids users in entry of data through a website, uploads data to a centralized server, allows access by remote data processors, process the data, and automates quality control and clinical reports. Process 1200 can be performed through any type of network, e.g., Internet, Intranet, LAN, and so on, and can include other automated functions performed by the centralized server.

In step 1210, the user logs to a Website. In step 1215, the user provides authentication using a unique identifier and password, or other form of security (e.g., electronic signature, finger print biometrics, or other information). In step 1220, the user has access to proprietary documents that provide standard operating procedures (SOPs) that may be used for the collection, processing, transfer, and storage of clinical trial data. Then, in step 1225, the user accesses the upload data function. This is one of many functions, which may enable the user to also download data, review data, review reports or manage accounts. In step 1230, the data is transferred to a centralized location for processing. After data are received, they can be processed by individuals with remote access to the centralized server. In step 1240, data processors can log on to the centralized server and process data using a data processing application in accordance with SOPs. In step 1245, a percentage of all files processed are processed a second time by an independent rater in order to assess inter-rater reliability and assure the statistical variance between individual raters is reduced. In step 1250, automated and manual quality control is performed to identify and correct any additional errors. In step 1255, once the files are processed, the raw data, processed data, results and reports are placed into a database or posted back to the Website application. In step 1260, an automated clinical report is generated using the raw and processed data.

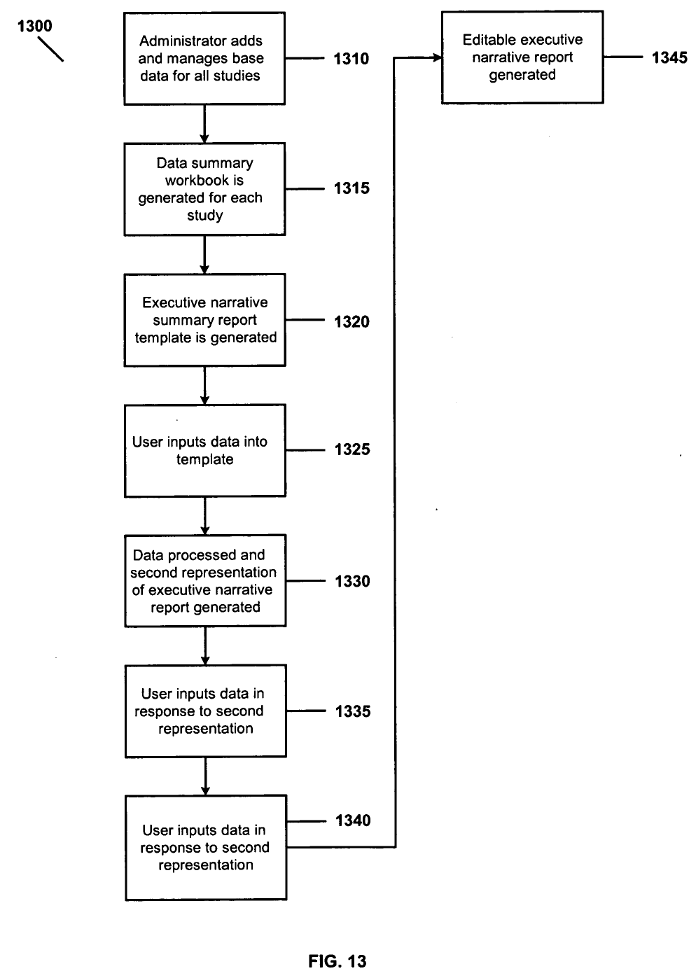

FIG. 13 is a flow diagram illustrating the process of generating a narrative summary report using the Executive Narrative Summary Report Generation (“ENSRG”) system, a feature of the Web-based centralized data management system in one embodiment. By way of example, process 1300 assists users in generating Executive Narrative Summary Reports. Process 1300 aids data administrators and users (e.g., Fellows) in entering base data and raw data, generating templates, processing data for initial reports, and generating final reports. The administrator is typically responsible for adding, updating, and deleting the base and raw data sets, in step 1310. Process 1300 can be performed through any type of network, e.g., Internet, Intranet, LAN, and so on, and can include other automated functions.

An administrator (e.g., Data Administrator Clerk) modifies the data summary report for each study into a data summary workbook. In step 1315, the process generates this modified summary workbook for each study. The modified workbooks are based on the electronic input to a web-based applications, part of the Executive Narrative Summary System, which allow input of data via the Internet. In step 1320, an Executive Narrative Summary Report template is generated and presented to the user. In step 1325, the user is allowed to make choices and selections to fill in the template to populate a “first draft” of the Executive Narrative Summary report. In step 1330, the data is processed and a second representation of the Executive Narrative Summary Report is generated, requiring additional input from the user in response to the initial selections made by the user. In step 1335, the user provides additional input to complete the “first draft.” In step 1335, the input is processed and a free-form, text-editable “first draft” of the Executive Narrative Summary Report is generated. The user can elicit response and comments from others, including a supervising medical director, and make final edits to the full-page, text-editable document generated.

In one embodiment, automated clinical reports are generated using raw and processed data. The reports may be returned to users.

Additional features may be included that enable users to perform functions that facilitate data processing. These include features that allow users to establish multiple accounts, manage accounts, obtain detailed file information, sort data, obtain billing information, and search for files.

Administrative aspects of some embodiments may enable an administrator to obtain information about each account that may be used for account management, billing, or other purposes.

Some embodiments include a web-based Executive Narrative Summary Report Generation (“ENSRG”) system, which provides automation assistance for generating executive narrative summary reports.

The ENSRG system replaces the need for Fellows to manually compose and orally dictate their executive narrative summary reports. It also eliminates the turn-around time to receive a draft report from the dictation service, as well as the need to make corrections to the draft, return it to the dictation service, and receive a final version back from the service for signature and release.

The inputs to the ENSRG system may be in the form of, for instance, data summary reports in Microsoft Excel electronic format.

The outputs from the ENSRG system may be in the form of, for instance, hard-copy printouts of the executive narrative summary reports that are generated and stored in electronic format within the system.

There are two actors that interact with the ENSRG system: the Fellows, and the Administrator. The main process focuses on the activities of the Fellow, interacting with the system, to create, revise, and print out the Executive Narrative Summary Report.

There is one input to this system. It may be, for example, a modified Microsoft Excel workbook that contains the data summary report for each sleep study. The original Microsoft Excel workbook is “exported” from the Grass Gamma system. There is one such workbook for each sleep study. This original workbook is then modified by a Data Administration Clerk who uses an Excel Macro to: (a) add or over-ride information about the sleep study; and (b) generate the Data Summary Report, which is represented as an additional Worksheet in the Microsoft Excel workbook. This modified workbook is the electronic input to the web-based Executive Narrative Summary system. Additionally, the Data Administration Clerk prints out the data summary report, which will be useful, as a hard-copy record, for the Fellow assigned to that sleep study.

There may be a number of outputs from the system. The system allows users to print out hard copies of the Executive Narrative Summary Reports that the system generates and stores.

A Fellow is assigned a set of sleep studies which he must analyze and for which he must produce an executive narrative summary report. He has, at his disposal, a printout of the data summary report for that sleep study, as well as other relevant documentation about that patient and that sleep study.

For each sleep study, the Fellow interacts with the system as follows: The Fellow imports the electronic version of the modified Microsoft Excel Workbook for that sleep study. Next, the System presents an Executive Narrative Summary Report template to the Fellow, allowing the Fellow to make choices and selections to fill in the template and produce a first draft narrative report. Then, the Fellow prints out a hard-copy first draft of the narrative report and presents it to his supervisor (i.e., the Clinical Director) for any revisions. After receiving any revisions from his supervisor, the Fellow returns to the system, calls up the draft report, and makes the necessary revisions. Finally, the Fellow prints out the final report for hard-copy distribution.

The Administrator manages “base data” that is used to provide choices and selections to the Fellow as he (the Fellow) fills in the report template. “Base Data” includes: list(s) of sleep study types needed for the sleep study type sub-section template; list(s) of symptoms needed for the chief complaint sub-section template; list(s) of medications needed for the chief complaint sub-section template; set(s) of impressions sub-section templates; list(s) of diagnoses needed for the diagnoses sub-section template; list(s) of recommendations needed for the recommendations sub-section template; set(s) of disposition sub-section templates; and list(s) of Fellows and an electronic picture representation of their signature-by-hand. The Administrator is responsible for adding, updating, and deleting this base data.

The Fellow peruses his stack of hard-copy sleep study case assignments. He will use the system to process each case, one case at a time. Having chosen one of the hard-copy sleep study cases, the Fellow begins to use the system to generate an executive narrative summary report for that case. The Fellow tells the system to browse the office LAN file directories in order to locate the modified Microsoft Excel Workbook for that case. Having located this electronic file, the Fellow tells the system to import it. Having imported the modified Microsoft Excel Workbook, the system does preliminary processing of this file, storing all the data elements that are in the Workbook into its database. There is one logical database entry for every sleep study stored in the system.

Next, the system provides a set of screens to allow the Fellow to fill in a fully populated a “first draft” of the Executive Narrative Summary Report from a skeletal report template.

Sub-section 1 consists of “Patient Information.” This sub-section includes patient information values (patient name, patient number, etc.). The Fellow does not need to interact with the system to fill in first-draft values, because these values were picked up by the system when it imported the modified Microsoft Excel Workbook for that sleep study case.

Sub-section 2 consists of “Sleep Study Type Information.” This sub-section includes descriptive information about the type of sleep study, e.g. “What procedures were involved?”, “Which treatments were involved?” Using a drop-down pick-list, the Fellow selects what type of sleep study this was.

Sub-section 3 consists of “Chief Complaint.” This sub-section introduces the patient, including identifying the complaints that caused the patient to come in for a sleep study and the medications that the patient is currently taking. Using a multi-select box, the Fellow selects the set of symptoms that the patient is suffering. Using a multi-select box, the Fellow selects the set of medications that the patient is currently taking.

Sub-section 4 consists of “Impression.” This sub-section describes both the flow of events (what occurred) during the sleep study itself and the impressions and observations of the Fellow with regard to this flow of events. Using a drop-down pick list, the Fellow chooses the appropriate sub-section template from among the available set.

Sub-section 5 consists of “Diagnosis.” This sub-section lists the formal set of medical diagnoses (diagnostic code and description), for this patient. Using a multi-select box, the Fellow selects the set of diagnoses for this patient, based on this sleep study.

Sub-section 6 consists of “Recommendations.” This sub-section lists the set of treatment recommendations for this patient. Using a multi-select box, the Fellow selects the set of recommendations for this patient, based on this sleep study.

Sub-section 7 consists of “Disposition.” This sub-section explains how this sleep study is being “disposed”. (E.g., patient will be informed; referring physician will be informed; request for a CPAP machine will be placed with the patient's provider, etc.). Using a drop-down pick-list, the Fellow chooses one from a list of disposition sub-section templates.

Sub-section 8 consists of “Signatures.” This sub-section identifies the two signators for this report: a supervising Medical Director and the responsible Fellow. It displays the name of the individual, the functional title, and a picture of that individual's hand-signature. Using a drop-down pick list, the Fellow chooses the supervising Medical Director. Using a drop-down pick list, the Fellow chooses the responsible Fellow. At this point, the Fellow “Submits” this initial representation (represented as distinct sub-sections) back to the system to continue automation processing.

The system processes this initial representation and prepares a second representation (represented as a full-page, single screen display) of the Executive Narrative Summary Report.

Within each of the sub-sections of this second representation (as a full-page report), there are now some additional pick-list phrases and blank (fill-in) phrases that the Fellow must resolve in order to complete the “First Draft”. The Fellow reads this second representation from the top, and uses the pick-list boxes and the fill-in boxes to complete the “First Draft.” At this point, the Fellow “Submits” this second representation back to the system to continue automation processing.

The system processes this second representation and prepares a full-page, fully-editable representation (“final representation”) of the Executive Narrative Summary Report. The system now presents this “final representation” to the Fellow, permitting the Fellow to free-form, text-edit any part of the Executive Narrative Summary Report. The Fellow reads this final representation and free-form, text-edits it as needed. At this point, the Fellow “Submits” this final representation back to the system for safe storage. This is the final “First Draft”. The Fellow prints out this final “First Draft” for review with or by the supervising medical director.

After receiving any revisions from the supervising medical director, the Fellow accesses the system in order to make any needed final edits and then print out a hard-copy of the final Executive Narrative Summary Report for that patient sleep study. Using the sleep study identification number, the Fellow identifies the sleep study to the system. The system presents the sleep study in its free-form, text-editable format. The Fellow makes any necessary free-form, text-edits. At this point, the Fellow “Submits” this final approved version of the report back to the system for safe storage. This is the final approved version of the report. The Fellow prints out this final approved version of the report for hard-copy distribution.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention as set forth in the appended claims.

1. A method for processing clinical data from a clinical trial, comprising the steps of:
providing a website for a first user to log on;
authenticating the identity of the first user;
allowing the first user to perform functions on a set of stored clinical data;
uploading a clinical data input from the first user;
transferring the clinical data input to a central server;
allowing a second user access to the central server;
processing the clinical data input in accordance with input from the second user to produce processed clinical data;
identifying a presence or an absence of a data error in the clinical data input;
if the presence of a data error in the clinical data input is identified, correcting the data error in the clinical data input; and
generating a clinical report comprising processed clinical data based on the clinical data input.

2. The method according to claim 1, wherein authenticating the identity of the first user comprises requiring the first user to provide identifying information.

3. The method according to claim 2, wherein requiring the first user to provide identifying information comprises requiring the first user to provide an electronic signature.

4. The method according to claim 1, wherein allowing the first user to perform functions on a set of stored clinical data comprises allowing the first user to perform functions on a set of stored clinical data in accordance with a set of specified standard operating procedures used by the clinical trial.

5. The method according to claim 1, wherein the second user is a data processor.

6. The method according to claim 1, wherein transferring the data to a central server comprises encrypting the data in accordance with HIPAA guidelines and 21 CFR Part 11.

7. The method according to claim 1, wherein allowing a second user access to the central server comprises providing remote access to the central server.

8. The method according to claim 7, wherein providing remote access to the central server comprises providing remote access to the central server via a web browser interface.

9. The method according to claim 1, wherein processing the clinical data input in accordance with input from the second user comprises utilizing a data processing application to process the clinical data input.

10. The method according to claim 9, wherein utilizing a data processing application to process the clinical data input comprises utilizing a data processing application to process the clinical data input in accordance with specified standard operating procedures used by the clinical trial.

11. The method according to claim 10, further comprising re-processing the clinical data input by a third user to produce reprocessed clinical data.

12. The method according to claim 1, further comprising:
placing the clinical data input, the processed clinical data and the clinical report into a database; and
allowing the first user or the second user access to the database via the website.

13. A method for generating a narrative clinical trial report, the method comprising the steps of:
generating a summary workbook from clinical trials data;
generating a report template from the summary workbook;
providing a set of first selections to a primary user to input data for individual case studies;
providing a set of second selections to the primary user based on the input from the first selections; and
generating a text-editable narrative report.

14. The method according to claim 13, wherein a secondary user accesses the clinical trials data, and the secondary user further performs the steps of:
editing the clinical trials data; and
providing fields for the report template.

15. The method according to claim 13, wherein the clinical trials data is input via the Internet.

16. The method according to claim 13, wherein the set of first selections is provided by drop-down menus for the primary user.

17. The method according to claim 13, wherein the set of second selections is provided by pick-list phrase boxes for the primary user.

18. The method according to claim 13, wherein the set of second selections is provided by fill-in boxes for the primary user.
